(19) United States
(12) Patent Application Publication
(10) Pub. No.: US 2025/0277402 A1
(43) Pub. Date: Sep. 4, 2025

(54) COEXTRUSION PROFILE, METHOD FOR PRODUCING A COEXTRUSION PROFILE, AND DOOR AND/OR WINDOW SYSTEM

(71) Applicant: Salamander Industrie-Produkte GmbH, Türkheim (DE)

(72) Inventor: Till Schmiedeknecht, München (DE)

(73) Assignee: Salamander Industrie-Produkte GmbH, Türkheim (DE)

(21) Appl. No.: 19/209,415

(22) Filed: May 15, 2025

Related U.S. Application Data
(62) Division of application No. 17/841,988, filed on Jun. 16, 2022.

(30) Foreign Application Priority Data
Jun. 16, 2021 (EP) 21179875.6

(51) Int. Cl. E06B 3/20; B29C 48/00; B29C 48/12; B29K 27/06; B29K 67/00; B29L 31/00

(52) U.S. Cl. CPC E06B 3/205; B29C 48/0015; B29C 48/12; B29K 2027/06; B29K 2067/003; B29L 2031/005

(57) ABSTRACT

A coextrusion profile for a window and/or door part, or a secondary profile to be attached to a window and/or door part, may include a hollow profile forming an outer side of the coextrusion profile and a hollow profile wall made of plastic and a foam core made of plastic foamed within the hollow profile. The window and/or door part may include a window and/or door frame part, a window and/or door sash part, such as a sliding window or a sliding door.

### CROSS REFERENCE TO RELATED APPLICATIONS

This patent application is a divisional patent application of U.S. patent application Ser. No. 17/841,988, filed Jun. 16, 2022, which claims priority to European Patent Application No. 21179875.6, filed Jun. 16, 2021, each of which is incorporated herein by reference in its entirety.

### BACKGROUND

### Field

The present disclosure relates to a coextrusion profile made of plastic, such as PVC, for a door and/or window system, for example of a passive house. In addition, the present disclosure also relates to a method and an extrusion tool for producing a coextrusion profile. Furthermore, the present disclosure provides a door and/or a window system comprising a coextrusion profile.

### Related Art

Generally, PVC extrusion profiles for windows and/or doors have both a steel stiffener for structural reasons and to enable the screwing of fittings, and an insulation filling of either PS or EPS to achieve a good heat transfer coefficient (U-value). For example, roll-formed steel profiles are used, which on the one hand provide the statics of the windows and at the same time serve as a screw base for the fittings. To achieve a significantly improved U-value, it is necessary to insert insulating material made of PS or EPS foam within the hollow spaces of the extrusion profiles. For example, the insulating materials are inserted into the steel stiffeners in the hollow spaces of the extrusion profiles or are completely foamed out so that the foam forms a firm bond with the extrusion profile. The use of steel profiles is also necessary in that as they serve as counter bearings for the screw connection in the masonry and the fittings.

DE102008009495A1 discloses such a known PU window frame profile with a hollow space and a foam insulating material completely filling it. Additional reinforcing elements in the form of stability-increasing fiber inserts, tubes made of plastic or a fiber composite material or a fitting part are incorporated in the insulating material to ensure the required mechanical stability of the window frame profile. The reinforcing elements are already placed in the mold during the foaming of the foam insulation material and are encapsulated by the foam. The foam insulation material stiffened by the reinforcing element is then encapsulated by a rigid polyurethane sheathing in an injection molding process. The disadvantages of the known extrusion profiles are the complex production method and the high number of components required to ensure sufficient strength and stiffness of the extrusion profiles and a sufficient insulating effect.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a door and/or window system with coextrusion profiles according to an exemplary embodiment of the disclosure.

FIG. 2 shows a door and/or window system with coextrusion profiles according to an exemplary embodiment of the disclosure.

FIG. 3 shows a door and/or window system with coextrusion profiles according to an exemplary embodiment of the disclosure.

FIG. 4 shows a door and/or window system with coextrusion profiles according to an exemplary embodiment of the disclosure.

FIG. 5 shows a Coextrusion profile with multiple anchoring protrusions on an inner side of the hollow profile wall according to an exemplary embodiment of the disclosure.

FIG. 6 shows a manufacturing device for the production of a coextrusion profile according to an exemplary embodiment of the disclosure.

FIG. 7 shows an outlet opening of an extrusion tool for the plastic melt for forming a hollow profile wall forming a profile outer side of a coextrusion profile according to an exemplary embodiment of the disclosure.

FIG. 8 shows an arrangement of several outlet openings of an extrusion tool for introducing the plastic melt to form the foam core into the hollow profile according to an exemplary embodiment of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to improve the disadvantages of the conventional technologies, including to provide an extrusion profile that is easier to manufacture and/or has fewer components and, in particular, higher stiffness and/or a better insulating effect.

According to this, a coextrusion profile is provided for a window and/or door part, in particular a window and/or door frame part, a window and/or door sash part, for example a sliding window or a sliding door, or a secondary profile to be attached to a window and/or door part, for example of a passive house. The coextrusion profile is defined by an extrusion direction which is the longitudinal direction of the coextrusion profile into which the coextrusion profile essentially does not change in cross-section. The coextrusion profiles according to the disclosure can be used, for example, for door and/or window systems which form a door and/or window profile frame, for example a frame profile of a pivotable or linearly displaceable sliding sash, a frame profile of a stationary so-called fixed sash, a faceplate or a mullion, a profile frame of door and/or window frames in building wall surrounds, such as a border profile, or supplementary frame parts, such as a lining strip profile or a faceplate profile.

According to exemplary embodiments of the disclosure, the coextrusion profile may include an outer surface of the hollow profile forming coextrusion profile, comprising a hollow profile wall made of plastic, for example PVC, and a foam core made of plastic, for example PET, which is foamed or expanded within the hollow profile. In other words, the hollow profile and the foam core are coextruded. In this case, molten plastic material can be foamed to form the foam core within the hollow profile, in particular simultaneously with the extrusion of the hollow profile wall. The foam core can thereby expand within the hollow profile wall and in this way be produced already during the production of the hollow profile wall, in particular simultaneously. For example, the foaming of the foam core can be coordinated with the extrusion of the hollow profile wall in such a way that the hollow profile wall has already cooled down to some extent. In other words, the coextrusion can be simultaneous, but with a time offset with respect to the dispensing of the respective material of the hollow profile wall and foam core, in particular by means of the coextrusion nozzle and/or by means of two extrusion nozzle matched to each other. The coextrusion of foam core and hollow profile is accompanied by a particularly dimensionally accurate connection of foam core and hollow profile. In this context, the term “connection” does not necessarily refer to a material bond between the foam core and the hollow profile, but rather to an arrangement of the foam core within the hollow profile. The foaming of the foam core within the hollow profile can result in the foam core fitting which adapts to the inside of the hollow profile, in particular in a form-fitting and/or form-fitting manner. For example, foaming of the foam core within the hollow profile can be carried out in such a way that a relative movement of foam core and hollow profile transverse to the extrusion direction of at most 1.5 mm, in particular of at most 1 mm or of at most 0.5 mm, preferably excluded, is permitted. For example, the coextrusion can be adjusted, in particular the extrusion of the hollow profile and the extrusion of the foam core for its expansion can be coordinated with each other, in such a way that at least in the region of the mutually facing boundary surfaces of foam core and hollow profile a material bond is accompanied. One advantage of coextrusion is that it is possible to produce any profile cross-sections in a technically simple manner. By foaming the foam core material inside the hollow profile, it is possible to produce a foam core for any cross-sections of the hollow profile. The foam core acts as an insulating material, in particular to achieve a desired U-value. A significant advantage of the coextrusion profile according to the disclosure is that it can be produced particularly cost-effectively and/or has improved characteristic values, such as weight, strength and U-value.

For example, the coextrusion can be carried out in such a way that there are no gap areas between the outer contour of the foam core to the inner contour of the hollow profile wall. This can be achieved, for example, by metering the amount of foam, in particular by increasing it so that the volume bounded by the hollow profile is completely filled, i.e. at least 90%, 95% or at least 99%. The outer contour surface of the foam core facing the hollow profile, i.e. its interface, is free of mechanical reworking and/or handling marks. The mutually facing boundary surfaces of hollow profile and foam core have matching surface structures. By foaming the foam inside the hollow profile during coextrusion, the hollow profile influences the density and the surface of the foam core and its foam structure.

In the production of a coextrusion profile according to the disclosure, the hollow profile wall and the foam core can be produced simultaneously in one process step by means of coextrusion. To produce the hollow profile wall and the foam core simultaneously, molten plastic pellets and/or plastic recyclate can be extruded within the hollow profile to form the foam core during extrusion of the hollow profile wall from molten plastic material, and foamed there. In an exemplary embodiment, the same extrusion tool can be used for the extrusion of the hollow profile wall and the foam core. In this way, the hollow profile wall and the foam core can be produced simultaneously in one process step with the same extrusion tool.

The foam core may be chemically foamed with the addition of inorganic blowing agents and nucleating agents, such as talc (H₂Mg₃O₂Si₄) with a molecular weight of 397.27, sodium bicarbonate (NaHCO₃/CHNaO₃), also known as sodium hydrogen carbonate, with a molecular weight of 84.007 and a monoisotropic mass of 83.98, or ammonium carbonate (CH₈N₂O₃). The sodium bicarbonate may be a monosodium salt of the carbonic acid with alkalinizing properties, which can be used as a crystalline powder or in agglomerates. The inorganic blowing agents and nucleating agents decompose when heated in the extruder, releasing gases that allow the molten plastic to foam. For example, sodium bicarbonate decomposes when heated above 50° C., releasing CO₂, H₂O and Na₂Co₃, with complete decomposition at 270° C. In this case, 4,4-oxybis (benzenesulfonyl hyrazide), for example, can be used to control the decay. Ammonium carbonate can be used in powder form and has a molecular weight of 96.09 and a monoisotropic mass of 96.053. It decomposes upon heating to form ammonia and CO2. Alternatively or additionally, 5(1-pentylterazol-5-yl)-benzene-1,3-diamine (C₁₂H₁₈N₆) with a molecular weight of 246.31 can be used. Alternatively or in addition to the inorganic blowing agents and nucleating agents, organic blowing agents and nucleating agents can be used such as azodicarbonamide ADC (C₂N₄H₄O₂) with a synonym of azodicaboxamide and azobisformamide, a molecular weight of 116.08 and a decomposition temperature of 225° C. Alternatively or in addition to the inorganic and/or organic blowing agents and nucleating agents, foaming can also be carried out physically by means of highly compressed gases, such as CO₂ or N₂ in the high-pressure process or ethanol, pentane, butane in the low-pressure process. Furthermore, it is conceivable to carry out the foaming process in the production of the foam core using so-called microspheres, which can be described as low-boiling liquids enclosed in hollow acrylate beads, such as iso-butane, -pentane, -octane or the like, and which can be metered directly into the plastic granules or plastic recyclate like chemical blowing agents. In order to improve the foaming behavior of the plastic granules or plastic recyclate, to reduce the decay or bursting of foam bubbles in the process and to produce an extrusion-ready behavior of the plastic melt, chain extenders for increasing the intrinsic viscosity of the plastic melt, so-called chain extenders, can be implemented into the extrusion method. Organic or inorganic additives or polymers can be used as chain extenders. For example, pyromellitic dianhydride (PMDA), diisocyanate, diepoxide, 1,6-diisocyanatohexane, 1,4-butanediol diglycidyl ether (EPOX), 1,4-phenylene bis-oxazoline (PBO), 1,4-phenylene diisocyanate (PDI) and/or triphenyl phosphite (TPP) can be used as chain extenders.

According to an exemplary embodiment of a coextrusion profile according to the disclosure, the foam core substantially completely foams out the hollow profile and/or substantially completely occupies an inner volume defined by the hollow profile. Alternatively or additionally, the hollow profile is free of internal webs forming hollow spaces. The hollow profile wall can thus form a closed hollow wall structure of any desired cross-section, which delimits a single full cavity, which is essentially completely filled with foamed foam core material. Such coextrusion profiles are thus significantly less complex than profiles with complex inner structures and inner webs known in the prior art to date, which could only be produced with complex and expensive tools. In contrast, the coextrusion profiles according to the disclosure can be produced with inexpensive tools.

In another exemplary embodiment of the present disclosure, the foam core expands during foaming in such a way that it lies firmly against the hollow profile wall and/or is frictionally fastened thereto. Due to the expansion of the foam core, which is, for example, temperature-dependent, the foam core can lie flush against an inner side of the hollow profile wall and a sufficiently high holding or fastening force can be ensured between the foam core and the hollow profile wall. For example, the foam core can be in complete contact with the hollow profile wall when viewed in the circumferential direction. In an exemplary embodiment, the expansion wedges the foam core to the hollow profile wall. By securing the foam core and the hollow profile wall in this manner, the foam core can be prevented from shifting in the extrusion direction within the hollow profile. Additional bonding of the foam core to the hollow profile wall or additional connecting elements are therefore not necessary. In this way, the foam core can be attached to the hollow profile wall in a simple and cost-effective manner, in particular by bonding.

In another exemplary embodiment, at least one rib extending in the extrusion direction projects from an inner side of the hollow profile wall. The rib extends into the interior of the hollow profile and is, preferably completely, from the foam core foamed around. The foamed around rib supports a non-rotational arrangement of the foam core within the hollow profile. Furthermore, the rib, the force transfer to the foam core can be improved by increasing the contact area between the foam core and the hollow profile wall. In this way, the structural strength of the connection can be improved. The rib can be extruded together with the hollow profile wall during extrusion of the hollow profile, so that no additional manufacturing or machining steps are required.

In an exemplary embodiment, at least one anchoring projection axtending in the extrusion direction is formed on an inner side of the hollow profile wall. Alternatively or additionally, an anchoring recess axtending in the extrusion direction is formed on the inner side of the hollow profile wall. The at least one anchoring protrusion and/or the at least one anchoring recess protrude from the inside of the hollow profile wall and are anchored in the foam core in a barb-like manner. The anchoring protrusion and/or anchoring recess also increase the contact area between the foam core and the hollow profile wall and thus also improve the force transmission between the foam core and the hollow profile wall, resulting in higher structural strength of the connection. The anchoring protrusion and/or anchoring recess can also be extruded together with the hollow profile wall during the extrusion of the hollow profile wall, so that no additional manufacturing or machining steps are required. The force transmission between the anchoring projection or anchoring recess and the foam core can be oriented transversely, in particular perpendicularly, to the extrusion direction.

In an exemplary embodiment, the at least one anchoring projection and/or the at least one anchoring recess has a C-, T- or L-shaped cross section. Alternatively or additionally, the at least one anchoring projection is completely foamed around by the foam core and/or the at least one anchoring recess is completely foamed by the foam core.

In another exemplary embodiment, the hollow profile wall comprises PVC and/or a wall thickness in the range of 0.2 mm to 6 mm, particularly in the range of 0.3 mm to 5 mm or in the range of 0.4 mm to 4.5 mm.

According to another exemplary embodiment, the foam core is made of a plastic having an average density in the range from 80 kg/m³ to 250 kg/m³, in particular in the range from 100 kg/m³ to 200 kg/m³, in the range from 110 kg/m³ to 150 kg/m³, in the range from 110 kg/m³ to 130 kg/m³ or of about 115 kg/m³, for example made of PET.

The combination of a PET foam core and a plastic hollow profile wall, for example made of PVC, has proven to be advantageous in that the foam core made of PET absorbs compressive forces while the plastic hollow profile wall absorbs tensile forces. In this respect, the coextrusion profile functions similarly to a truss. The PET foam core also exhibits sufficient resistance to pull-out and/or tear-out of a bolted connection.

For example, the foam core has a compressive strength of at least 0.3 N/mm², in particular at least 0.5 N/mm², 0.75 N/mm², 1.0 N/mm², 1.25 N/mm² or at least 1.5 N/mm².

To determine the compressive strength, the standard test method according to ASTM D1621 can be used, by means of which the compressive properties of hard foams, in particular hard foam plastics, can be determined and tested. A significant advantage of using a PET foam core is that further stiffening measures, such as the steel stiffeners usually inserted in the hollow spaces, can be dispensed with. This is accompanied by other considerable advantages: reduced weight and thus costs, especially freight costs, as well as easier assembly. In particular, the use of a PET foam core has proved to be particularly advantageous for use in generic coextrusion profiles for door and/or window systems, for example in a passive house. In general, the PET foam core is a thermoplastic foam material with high mechanical and thermal properties and high resistance to moisture. As a result, the coextrusion profile can meet the static and strength requirements. Furthermore, the PET foam core is characterized by high thermal insulation properties and good fire behavior, so that passive houses in particular can achieve a good insulation value.

In another exemplary embodiment comprises the plastic of the hollow profile wall and/or of the foam core plastic recycling material, wherein in particular plastic recycling material is a mixture comprising a waste window granulate or ground material, for example from production waste from window and/or profile production, wherein the waste window granulate or ground material has a mass fraction of between 50 wt.-% and 100 wt.-% of the mixture, in particular between 80 wt.-% and 98 wt.-% of the mixture, between 90 wt.-% and 97 wt.-% of the mixture or about 95 wt.-% of the mixture.

“Used window granulate” in the sense of the present disclosure means a mixture which consists of old plastic frames which have already been previously installed and which are recycled again after use, and/or consists of plastic material which occurs in the course of the processing, for example at the window manufacturer or during the removal of the old windows. For the purposes of the present disclosure, the old, previously used plastic frames and/or the plastic material that occurs during the processing, for example at the window manufacturer or during the removal of the old windows, can be mixed together during processing to form the used window granulate. The old, already installed plastic frames and/or the plastic material, which occurs during the processing, for example at the window manufacturer or during the removal of the old windows, can also be present separately. For example, in the sense of the present disclosure, a recycled plastic material is used for a coextrusion profile according to the disclosure. A coextrusion profile made of a recycled plastic material is particularly advantageous because it is beneficial to the environment and because it is a CO₂-neutral product.

In another exemplary embodiment of a coextrusion profile according to the disclosure, the density of the foam core increases continuously from its center to the outside, i.e. there is a density gradient from the inside to the outside. The density near the edge can be at least twice, in particular three, four or five times, higher than the density in the region of the center. The increased density in the edge region can arise, for example, as a result of a limitation of the expansion of the foam core by the hollow profile wall. In addition, the density in the edge region can be further increased by the arrangement of the outlet openings for the plastic melt to form the foam core on an extrusion tool used for coextrusion. For example, more or larger outlet openings for the plastic melt to form the foam core can be arranged at the edge of the extrusion tool, so that a greater amount of foam material is extruded in the edge region of the hollow profile, in addition to limiting the expansion of the foam core by the hollow profile wall.

According to another aspect of the present disclosure, which can be combined with the preceding aspects and exemplary embodiments, a window and/or door part, in particular a window and/or door frame part or a window and/or door sash part, is provided. The window and/or door part is made from a coextrusion profile according to the disclosure. In this respect, the explanations made with respect to the coextrusion profiles according to the disclosure and the features and technical effects associated therewith are transferable to window and/or door parts according to the disclosure.

According to an exemplary embodiment of a window and/or door part according to the disclosure, the window and/or door part is produced by welding, in particular butt welding or corner welding, two coextrusion profiles according to the disclosure. In each case, the hollow profile walls are welded together and the foam cores are welded together. This results in a higher strength of the connection compared with extrusion profiles known in the prior art, in which only the outer profile walls are welded.

According to a further aspect of the present disclosure, which is related to the foregoing aspects and exemplary embodiments can be combined, a method for producing a coextrusion profile for a window and/or door part, in particular a window and/or door frame part or a window and/or door sash part, is provided. The method can be particularly configured in such a way that a coextrusion profile according to the disclosure is produced.

According to the disclosure, a foam core made of plastic, for example PET, and a hollow profile forming an outer side of the coextrusion profile with a hollow profile wall made of plastic, for example PVC, are coextruded in such a way that the plastic material foams and/or expands inside or within the hollow profile to form the foam core. The coextrusion of the foam core and the hollow profile results in a particularly dimensionally accurate connection between the foam core and the hollow profile. The connection does not necessarily have to be a material bond between the foam core and the hollow profile, foam core and hollow profile, but in principle an arrangement of the foam core within the hollow profile. The foaming of the foam core within the hollow profile can result in the foam core fitting adapts to the inside of the hollow profile, in particular in a form-fitting and/or shape-fitting manner. For example, the foaming of the foam core within the hollow profile in such a way that a relative movement of foam core and hollow profile transverse to the extrusion direction of at most 1.5 mm, in particular of at most 1 mm or of at most 0.5 mm, is preferably excluded. For example, the coextrusion can be adjusted, in particular the extrusion of the hollow profile and the extrusion of the foam core for its expansion can be coordinated with each other, in such a way that at least in the region of the mutually facing boundary surfaces of foam core and hollow profile a material bonding connection is accompanied. One advantage of coextrusion is that it is possible to produce any profile cross-sections in a technically simple manner. By foaming the foam core material inside the hollow profile, it is possible to produce a foam core for any cross-sections of the hollow profile. It may be provided that the plastic material for forming the foam core is extruded into the hollow profile simultaneously with the extrusion of the hollow profile wall. In this way, the hollow profile wall and the foam core can be produced simultaneously in one process step by means of coextrusion.

To create the hollow profile wall and the foam core inside the hollow profile at the same time, molten plastic pellets and/or plastic recyclate, for example PET, can be implemented into the hollow profile to form the foam core during extrusion of the hollow profile wall from molten plastic pellets and/or plastic recyclate, for example PVC, and foamed there. During coextrusion, the foam core expands, for example by thermal expansion, and thus bonds to the hollow profile wall already during production. In an exemplary embodiment, the same extrusion tool can be used for this purpose. For this purpose, the extrusion tool can have an outlet opening for the plastic melt to form the hollow profile wall and one or more further outlet openings for the plastic melt to form the foam core.

The foam core may be chemically foamed with the addition of inorganic blowing agents and nucleating agents, such as talc (H₂Mg₃O₂Si₄) with a molecular weight of 397.27, sodium bicarbonate (NaHCO₃/CHNaO₃), also known as sodium hydrogen carbonate, with a molecular weight of 84.007 and a monoisotropic mass of 83.98, or ammonium carbonate (CH₈N₂O₃). The sodium bicarbonate may be a monosodium salt of the carbonic acid with alkalinizing properties, which may be in the form of crystalline powder or in agglomerates can be used. The inorganic blowing agents and nucleating agents decompose when heated in the extruder, releasing gases that allow the molten plastic to foam. For example, sodium bicarbonate decomposes when heated above 50° C., releasing Co2, H₂O and Na₂Co₃, with complete decomposition at 270° C. In this case, 4,4-oxybis (benzenesulfonyl hyrazide), for example, can be used to control the decay. Ammonium carbonate can be used in powder form and has a molecular weight of 96.09 and a monoisotropic mass of 96.053. It decomposes upon heating to form ammonia and CO₂. Alternatively or additionally, 5(1-pentylterazol-5-yl)-benzene-1,3-diamine (C₁₂H₁₈N₆) with a molecular weight of 246.31 can be used. Alternatively or in addition to the inorganic blowing agents and nucleating agents, organic blowing agents and nucleating agents can be used such as azodicarbonamide ADC (C₂N₄H₄O₂) with a synonym of azodicaboxamide and azobisformamide, a molecular weight of 116.08 and a decomposition temperature of 225° C. Alternatively or in addition to the inorganic and/or organic blowing agents and nucleating agents, foaming can also be carried out physically by means of highly compressed gases, such as CO₂ or N₂ in the high-pressure process or ethanol, pentane, butane in the low-pressure process. Furthermore, it is conceivable to carry out the foaming process in the production of the foam core using so-called microspheres, which can be described as low-boiling liquids enclosed in hollow acrylate beads, such as iso-butane, -pentane, -octane or the like, and which can be metered directly into the plastic granules or plastic recyclate like chemical blowing agents. In order to improve the foaming behavior of the plastic granules or plastic recyclate, to reduce the decay or bursting of foam bubbles in the process and to produce an extrusion-ready behavior of the plastic melt, chain extenders for increasing the intrinsic viscosity of the plastic melt, so-called chain extenders, can be implemented into the extrusion method. Organic or inorganic additives or polymers can be used as chain extenders. For example, pyromellitic dianhydride (PMDA), diisocyanate, diepoxide, 1,6-diisocyanatohexane, 1,4-butanediol diglycidyl ether (EPOX), 1,4-phenylene bis-oxazoline (PBO), 1,4-phenylene diisocyanate (PDI) and/or triphenyl phosphite (TPP) can be used as chain extenders.

In an exemplary embodiment, the hollow profile wall is calibrated after extrusion, in particular dry calibrated. The calibration, in particular dry calibration, can directly follow the outlet opening of the extrusion tool for the plastic melt for forming the hollow profile wall. In this embodiment, the plastic melt for forming the foam core can be implemented within the cavity of the hollow profile in such a way that the plastic melt for forming the foam core foams within the calibrated hollow profile wall section.

In an exemplary embodiment, the hollow profile wall is cooled during calibration, in particular during dry calibration, so that the hollow profile wall partially solidifies. It may be provided that the hollow profile wall is cooled under vacuum during calibration, in particular dry calibration. The calibration may have the same outer contour as the outlet opening of the extrusion tool for the plastic melt to form the hollow profile wall, so that the plastic melt is cooled over the entire surface. Cooling during calibration can ensure that the hot, expanded plastic melt for forming the foam core does not hit the hollow profile wall until it has already cooled and solidified to such an extent that no impairment, for example deformation, of the hollow profile wall occurs as a result of the plastic melt. The plastic melt for forming the foam core can, for example, have a temperature of around 250° C. when it exits the extrusion tool.

In another exemplary further embodiment, the foam is extruded into a cavity of the hollow profile by means of a lance. In this embodiment, the one or more outlet opening for the plastic melt to form the foam core may be located at the end of the lance. The lance may further be sized such that the plastic melt for forming the foam core foams within the calibrated hollow profile wall portion. The plastic melt for forming the foam core can thus be implemented into the hollow profile with the aid of the lance at a certain distance from the outlet opening of the extrusion tool for the plastic melt for forming the hollow profile wall in order to be foamed there.

In accordance with another aspect of the present disclosure, which is related to the foregoing aspects and exemplary embodiments can be combined, an extrusion tool, in particular a coextrusion tool, for producing a coextrusion profile according to the disclosure or a window and/or door part according to the disclosure and/or for carrying out the coextrusion method according to the disclosure is provided.

In the following description of exemplary embodiments of the present disclosure, a coextrusion profile according to the disclosure is generally provided with the reference numeral 1, which is used in doors or windows, in particular in door or window frames, and is, for example, a frame profile, a sash profile, a widening profile of a sash or a frame, a mullion profile, a faceplate profile, a faceplate profile, a frame profile, for example in sliding doors or sliding windows, or a lining strip profile. The extrusion direction E is oriented in the drawing plane.

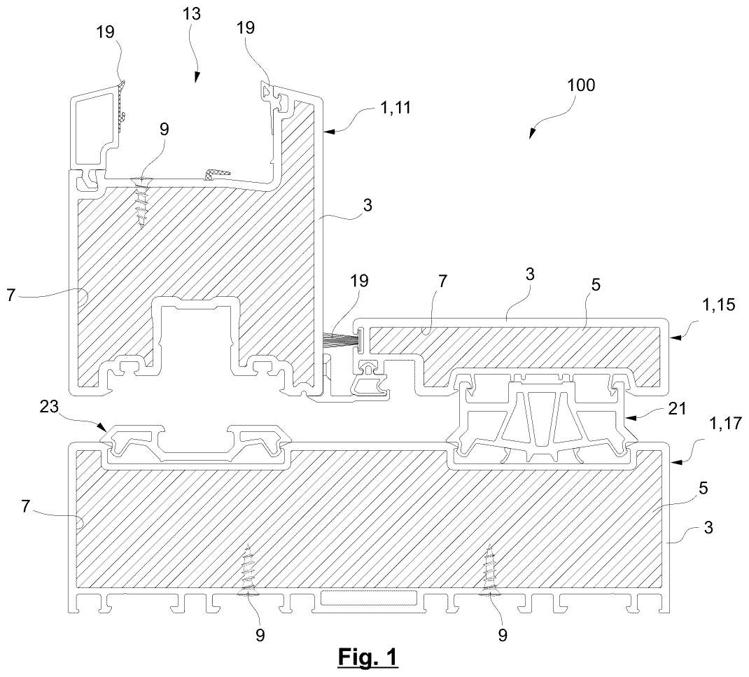

In the exemplary embodiments of FIGS. 1 to 4, the coextrusion profiles 1 according to the disclosure are part of door or window systems, which are generally provided with the reference numeral 100.

Coextrusion profiles 1 according to the disclosure essentially comprise the following main components: A hollow profile forming an outer side of the coextrusion profile 1 with a hollow profile wall 3 made of plastic, for example PVC, and a foam core 5 made of plastic, for example PET, foamed within the hollow profile, which preferably has a density in the range from 80 kg/m³ to 250 kg/m³. The coextrusion profiles 1 are free of profile webs or profile walls forming hollow spaces, so that the hollow profile wall 3, which is closed in the circumferential direction, i.e. viewed transversely to the extrusion direction E, delimits a single hollow space 7 which can be completely occupied by the foam core 5.

The hollow profile wall 3 and the foam core 5 can be produced simultaneously by means of coextrusion in one processing step, preferably with the same extrusion tool. According to the disclosure, the foam core 5 is foamed within the hollow profile. In an exemplary embodiment, the foam core 5 is extruded into the hollow profile during the extrusion of the hollow profile wall 3 and foamed there. Due to a temperature-dependent expansion of the foam core 5, for example, the hollow profile wall 3 and the foam core 5 are already frictionally attached to each other during production. This means that the hollow profile wall 3 and the foam core 5 cannot move away from each other. There is no need for gluing or other material bonding or for additional screw supports such as metal stiffening profiles.

The door and/or window system 100 illustrated in FIG. 1 has three coextrusion profiles 1 designed according to the disclosure, one of which is designed as a sash part 11 with a glazing groove 13 for receiving a glazing not shown, one as a lining strip 15 and one as a border 17. The window system 100 further comprises various seals, which are provided in simplified form with the reference sign 19, an adapter strip 21, which can be made of plastic, in particular PVC, in particular by extrusion, and a guide strip 23 made of plastic, in particular PVC, which can also be made by extrusion.

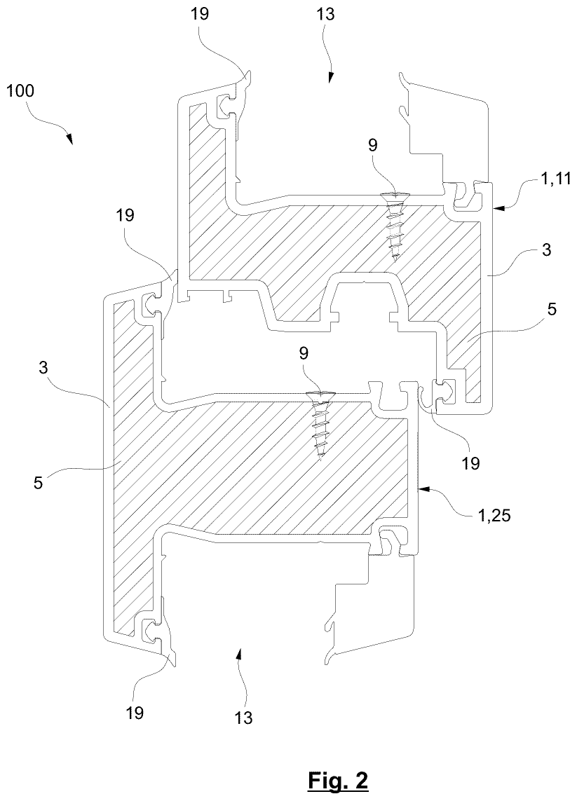

Identical components are given the same reference numbers in the following. The door and/or window system 100 of FIG. 2 has a coextrusion profile 1 forming a sash profile 11, which cooperates with a coextrusion profile 1 according to the disclosure formed as a mullion profile 25. The mullion profile 25 and the sash profile 11 each have a glazing groove 13 for receiving glazing not shown.

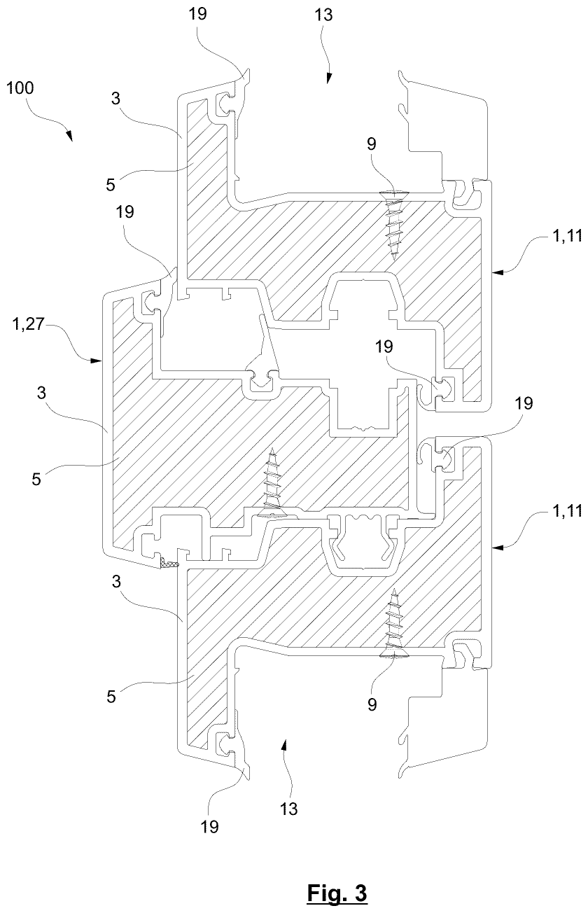

The door and/or window system 100 illustrated in FIG. 3 is basically similar in structure to the preceding door and/or window systems 100 and comprises a coextrusion profile 1 according to the disclosure, which is designed as a sash profile 11 and cooperates with a further coextrusion profile 1 according to the disclosure, which is in turn designed as a sash profile 11, via a secondary sash profile 27.

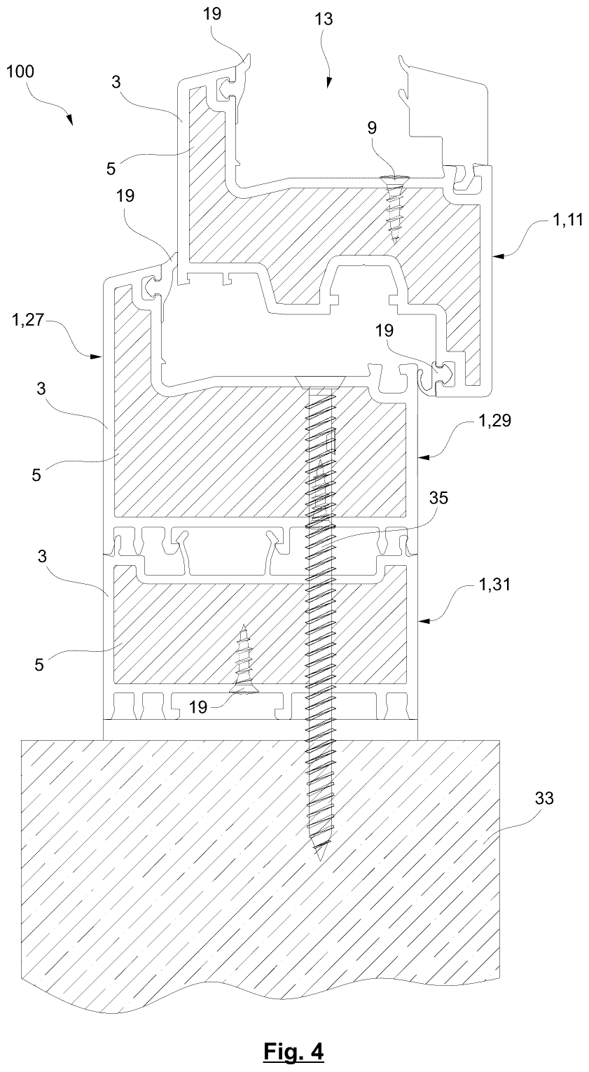

FIG. 4 is another exemplary design of a door and/or window system 100, which consists of a plurality of coextrusion profiles 1 according to the disclosure is shown, which has a profile configured as a sash profile 11, a coextrusion profile 1 formed as a frame profile 29, and an additional coextrusion profile 1 according to the disclosure formed as a widening profile 31. The door and/or window system 100 is illustrated in FIG. 4 in its assembled state on a developer 33, such as a building wall. The frame profile 29 and the widening profile 31 are screwed to the developer 33 via a screw connection 35.

In the exemplary embodiments in FIGS. 1 to 4, the foam core 5 of a coextrusion profile 1 according to the disclosure lies in each case flush with the surface, viewed in the circumferential direction completely against an inner side of the hollow profile wall 3 of the coextrusion profile 1 according to the disclosure, and wedges itself to the hollow profile wall 3 by means of, for example, a temperature-dependent expansion during the production of the coextrusion profile 1. In this way, a sufficient holding and fastening force between the foam core 5 and the hollow profile wall 3 can be ensured. By limiting the expansion of the foam core 5 through the hollow profile wall 3, the density of the foam core 5 increases continuously from its center to the outside, so there is a density gradient from the inside to the outside.

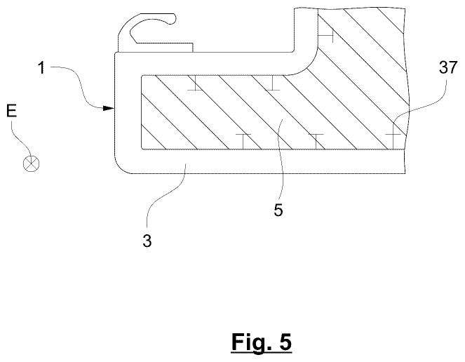

In the embodiment of a coextrusion profile 1 according to the disclosure in FIG. 5, the hollow profile wall 3 has on an inner side a plurality of anchoring projections 37 axtending in extrusion direction E. The anchoring projections 37 project into the interior of the hollow profile and are preferably completely foamed around by the foam core 5. The anchoring projections 37 have a T-shaped cross-section so that they are anchored in the foam core 5 in a barb-like manner. This can improve the force transfer between the foam core 5 and the hollow profile wall 3 by increasing the contact area between the foam core 5 and the hollow profile wall 3. In this way, the structural strength of the connection can be further improved compared to the embodiments in FIGS. 1 to 4.

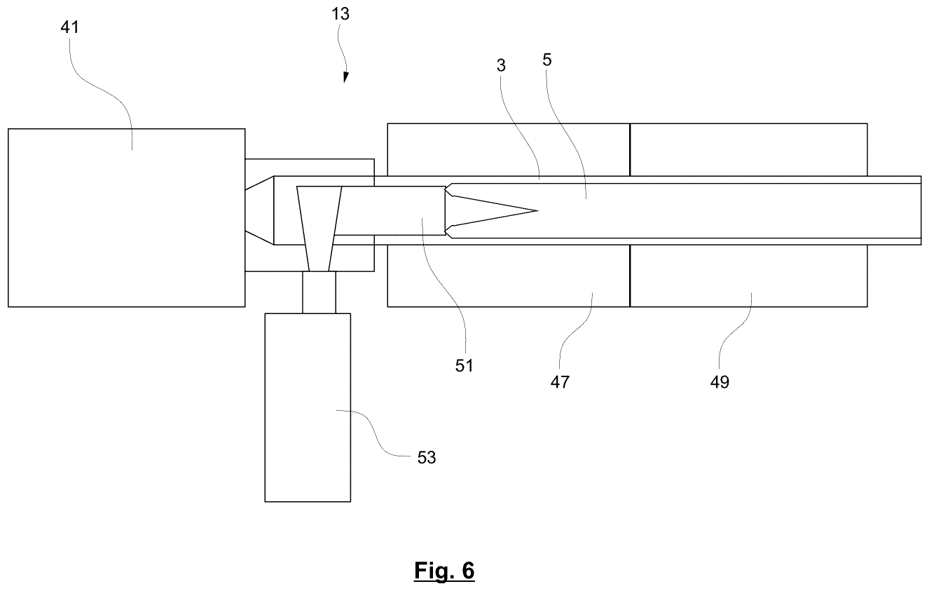

With reference to FIGS. 6 to 8, an exemplary production sequence and an exemplary extrusion tool 45 for producing a coextrusion profile 1 according to the disclosure are explained in detail below.

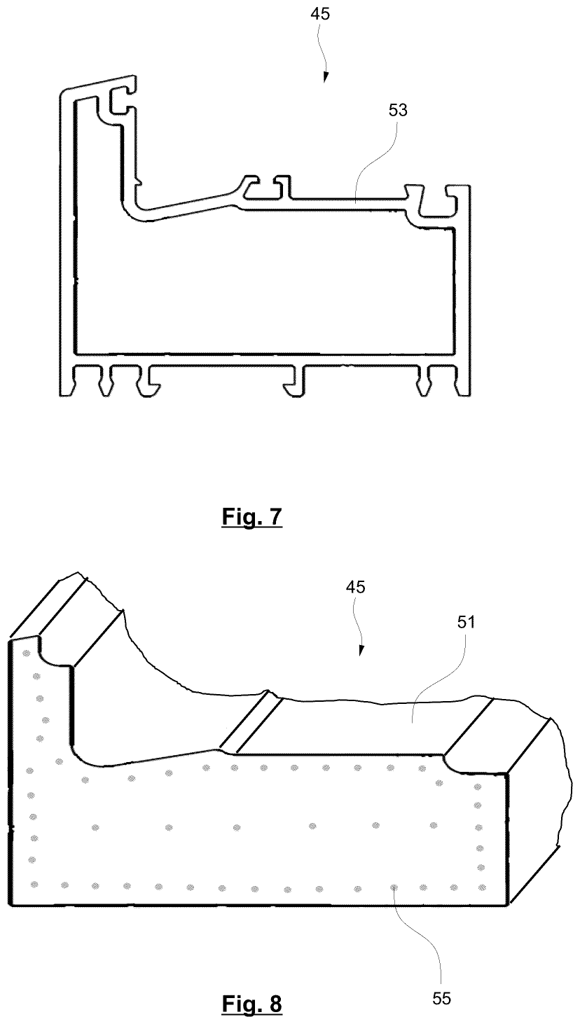

FIG. 6 shows an embodiment of a manufacturing device 39 for manufacturing coextrusion profiles 1 according to the disclosure. The manufacturing device 39 comprises an extruder 41 for plastic granulate, plastic dryblend or plastic recyclate, for example PVC, for forming the hollow profile wall 3 and an extruder 43 for plastic granulate or plastic recyclate, for example PET, with optional addition of chemical blowing agents and/or nucleation for forming the foam core 5. The manufacturing device 39 further comprises an extrusion tool 45, explained in more detail with reference to FIG. 7 and FIG. 8, for simultaneously extruding both the hollow profile wall 3 and the foam core 5 by means of coextrusion in a single process step. For this purpose, the extrusion tool 45 has an outlet opening for the plastic melt to form the hollow profile wall 3 and one or more further outlet openings for the plastic melt to form the foam core 5.

The extrusion tool 45 is followed by a dry calibration 47 in which the extruded hollow profile wall 3 is cooled, in particular under vacuum, and partially solidifies. The dry calibration 47 can have the same outer contour as an outlet opening 53 (see FIG. 7) for the plastic melt for forming the hollow profile wall 3 at the extrusion tool 45, so that the plastic melt is cooled over the entire surface. The dry calibration 47 can be followed by a wet calibration 49.

According to the disclosure, the plastic melt is foamed to form the foam core 5 inside the hollow profile. For this purpose, a physical blowing agent, such as CO2, N2, propane, or butane, can be added to the plastic melt to form the foam core 5. In an exemplary embodiment, the plastic melt for forming the foam core 5 is implemented into the hollow profile with a lance 51 within the dry calibration 47, i.e. at a certain distance from the outlet opening 53 for the plastic melt for forming the hollow profile wall 3, and foamed there. This ensures that the hot, expanded plastic melt for forming the foam core 5 does not hit the hollow profile wall 3 until it has already cooled and solidified to such an extent that the plastic melt does not cause any damage, for example deformation, to the hollow profile wall 3.

FIG. 7 shows an exemplary outlet opening 53 for the plastic melt to form the hollow profile wall 3. If anchoring projections 37 are also provided on an inner side of the hollow profile wall 3, as in FIG. 5, the outlet opening 53 for the plastic melt to form the hollow profile wall 3 can be adapted so that the anchoring projections 37 can be extruded together with the hollow profile wall 3 and no additional manufacturing or machining steps are required.

FIG. 8 shows an exemplary arrangement of several outlet openings 55 for the plastic melt for forming the foam core 5. The outlet openings 55 can be arranged at the end of a lance 51 adapted to the shape of the outlet opening 53 for the plastic melt for forming the hollow profile wall 3 for introducing the plastic melt for forming the foam core 5 into the hollow profile. In FIG. 8, it can be seen that fewer outlet openings 55 are provided in the center of the lance 51 than at the edge of the lance 51. In this way, the higher density of the foam core 5 close to the edge can be further increased, in that in addition to limiting the expansion of the foam core 5 by the hollow profile wall 3 in the edge area more plastic melt is extruded into the hollow profile to form the foam core 5.

The features disclosed in the foregoing description, figures, and claims may be significant both individually and in any combination for the realization of the disclosure in the various embodiments.

### CONCLUSION

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 Coextrusion profile
3 Hollow profile wall
5 Foam core
7 Cavity
9 Screw
11 Sash profile
13 Glazing groove
15 Lining strip profile
17 Border profile
19 Seal
21 Adapter strip
23 Guide strip
25 Mullion profile
27 Secondary sash profile
29 Frame profile
31 Widening profile
33 Developer
35 Screw
37 Anchoring protrusion
39 Manufacturing device
41 Extruder for the plastic melt to form the hollow profile wall.
43 Extruder for the plastic melt to form the foam core
45 Extrusion tool
47 Dry calibration
49 Wet calibration
51 Lance
53 Outlet for plastic melt to form the hollow profile wall
55 Outlets or plastic melt to form the foam core
E Extrusion direction

1. An extrusion method for producing a coextrusion profile for a window and/or door part, the method comprising:
coextruding a foam core made of plastic and a hollow profile forming an outer side of the coextrusion profile and having a hollow profile wall made of plastic,
wherein the foam core and the coextrusion profile are coextruded such that foam for the foam core foams within the hollow profile to form the foam core.

2. The extrusion method according to claim 1, further comprising: calibrating the hollow profile wall after extrusion, wherein the foam is extruded into a cavity of the hollow profile wall such that the foam foams to form the foam core within the calibrated hollow profile wall portion.

3. The extrusion method according to claim 2, wherein, during calibration, the hollow profile wall is cooled such that the hollow profile wall at least partially solidifies.

4. The extrusion method according to claim 1, wherein the foam is extruded into a cavity of the hollow profile by a lance.

5. The extrusion method according to claim 1, wherein the window and/or door part comprises a window and/or door frame part, a window and/or door sash part, and/or a sliding window or a sliding door.

6. The extrusion method according to claim 1, wherein the foam core completely fills an interior of the hollow profile.

7. The extrusion method according to claim 1, wherein the hollow profile is free of internal webs forming hollow spaces.

8. The extrusion method according to claim 1, wherein the foam core expands within an interior of the hollow profile during foaming to engage and be brought into contact with the hollow profile wall surrounding the expanding foam core such that the foam core lies firmly against the hollow profile wall and/or is force-fittingly fastened thereto.

9. The extrusion method according to claim 1, wherein the hollow profile wall comprises at least one rib extending in an extrusion direction projecting from an inner side of the hollow profile wall, the foam core being foamed around the at least one rib.

10. The extrusion method according to claim 1, wherein an inner side of the hollow profile wall comprises:
at least one anchoring projection extending in an extrusion direction, the at least one anchoring projection being configured to project from the inner side and anchor in the foam core in a barb-like manner; and/or
an anchoring recess extending in the extrusion direction formed on an inner side of the hollow profile wall.

11. The extrusion method according to claim 10, wherein the anchoring projection and/or the anchoring recess comprises a C-, T- or L-shaped cross-section and/or the anchoring projection is completely foamed around by the foam core and/or the anchoring recess is completely filled with the foam core.

12. The extrusion method according to claim 1, wherein: the hollow profile wall comprises polyvinyl chloride (PVC); and/or the hollow profile wall has a wall thickness in a range from 0.2 mm to 6 mm.

13. The extrusion method according to claim 1, wherein: the plastic of the foam core has an average density in a range from 80 kg/m³ to 250 kg/m³; and/or the foam core is made of polyethylene terephthalate (PET).

14. The extrusion method according to claim 1, wherein the foam core forms an inside of the coextrusion profile simultaneously with the formation of the outer side of the coextrusion profile.

15. The extrusion method according to claim 1, wherein the foam core is foamed simultaneously with an extrusion of the hollow profile to produce the coextrusion profile.

16. The extrusion method according to claim 1, wherein the plastic of the hollow profile wall and/or of the foam core comprises plastic recycling material including a mixture of a waste window granulate or ground material, the waste window granulate or ground material including a proportion by mass of between 50 wt.-% and 100 wt.-% of the mixture.

17. The extrusion method according to claim 1, wherein a density of the plastic of the foam core increases continuously from its center outwardly, a density near an edge being at least two times higher than a density in a central region.

18. The extrusion method according to claim 1, wherein the coextruding the foam core and the hollow profile comprises:
introducing a first plastic melt for the hollow profile wall;
introducing a second plastic melt for the foam core; and
processing the first and the second plastic melts to coextrude the foam core and the hollow profile to produce the coextrusion profile.

19. The extrusion method according to claim 18, wherein the coextrusion profile is produced using an extrusion tool comprising: a first outlet opening configured receive and process the first plastic melt, and a second outlet opening configured to receive and process the second plastic melt.

20. A window and/or door part produced from the coextrusion profile formed according to claim 1.
